(19) United States
(12) Patent Application Publication
(10) Pub. No.: US 2024/0185187 A1
(43) Pub. Date: Jun. 6, 2024

(54) SYSTEM AND METHODS TO CREATE, SHARE, CURATE, INTEGRATE, VIEW and ANALYZE SCHEDULES OF EVENTS

(71) Applicant: Gerard Dube, Naples, FL (US)

(72) Inventor: Gerard Dube, Naples, FL (US)

(21) Appl. No.: 18/529,932

(22) Filed: Dec. 5, 2023

Related U.S. Application Data
(60) Provisional application No. 63/386,009, filed on Dec. 5, 2022.

(51) Int. Cl. G06Q 10/1093; G06F 16/955

(52) U.S. Cl. CPC G06Q 10/1093; G06F 16/9554

(57) ABSTRACT

The present disclosure relates to schedules of events and more specifically, a unified process and methods to create, share, curate, integrate, view and analyze schedules of events in a single platform bringing together publishers and consumers of schedules content. This process includes a publisher opening an account in the Platform and creating a schedule of events. The Platform automatically generates a “savable” custom QR Code and Link for Publishers to use in marketing and promoting their schedule. Publisher may review user behavior for published schedules. Consumers can scan the QR Code or click a link to view the schedule. Consumers may save any schedule and curate to a save schedules list of their favorites. Users can view any schedule individually from the curated list of schedules with a single action (click, tap or voice command). Consumers are also provided a method of creating an integrated personal timeline of events from selected schedules and events. This platform functionality may be associated with a personal calendar or delivered as a stand-alone application for schedules.

### BACKGROUND OF THE INVENTION

This patent is primarily focused on an application and platform to simplify and improve the creation, marketing and management of public and semi-public events schedules.

An event schedule is a grouping of events on a calendar based around a common theme. Event groupings are not random but revolve around, for example; a school, band, team, community or club. An event schedule (sometimes also referred to as an event calendar) is how a person or entity keeps the public or small group informed on what is happening, when and where. The ease by which they can create, share, update and analyze their schedule is important to schedule creators.

A person's interest in specific event schedules is also not random. People tend to be interested in schedules that are relevant to them for example; the school schedule where their child goes to school, their local bar or venue, a friend's band, their team or their community and club. This affinity people have for certain schedules creates a loyalty where people want to consult these schedules on a regular basis to not miss anything. The ease by which they can access, save, retrieve, view and integrate different schedules were important factors when a new designing platform for simplifying the consumer experience around schedules.

Schedules take many forms, some are digital and on web sites, others are printed and handed out and still others are simply written on a white board for all to see. Our design accommodates all three of these options by auto-generating a custom QR Code (s) and link (s) for each schedule. This newly generated QR Codes/links can be used to market and promote the schedule in both the physical and online world and allows people to “take the schedule with you” since schedules can be scanned and saved.

QR Codes allow a person to scan and be directed, in this case, to a schedule. If for example the QR Code was used alongside an online calendar, the user may be prompted to scan or tap (link) and “save this schedule.” QR Codes can likewise be used on printed schedules to allow people to scan and save the printed schedule electronically. Saving schedules electronically is superior to putting a printed schedule in your pocket since printed schedules are often left behind and cannot be easily updated once distributed. However, scanning the QR Code of a printed schedule and saving it in electronic form, enables all updates to be immediately available to the user while the printed schedule may be out of date.

In this new platform, we call those who create, share and analyze schedules “Publishers” and those who want to view, save and integrate schedules and attend events “Consumers”.

The problem with today's approach to schedules is there is no consistent process for how schedules are created, shared, saved, integrated, viewed and analyzed. Each person or entity is on their own. This lack of consistency makes it inefficient and difficult for both Publishers and Consumers of schedules.

Publishers are generally dealing with public or semi-public schedules meant to be shared with others. No one creates a schedule to hide it. The whole idea is to promote the events to get maximum exposure to the schedule and increased attendance at events. Since sharing is the default for Publishers of event schedules, it would be advantageous to have a QR Code and Link to the schedule automatically generated once the schedule was created. This would save the Publisher taking additional steps to create a QR Code or link to better market and promote their schedule. In addition, QR Codes scans can be tallied and analyzed to improve targeting and results. The ability to analyze the user engagement on a per schedule basis allows Publishers to see the return on their efforts and change strategies based on these insights.

In today's technology climate, QR Codes have been widely accepted as a means of connecting a Consumer to menus, web pages and other content. Most of these connections are “one time” meaning the QR Code is scanned, a person looks at the menu or web page and then is finished. Since the user has no ability to save the target of the QR code, it is very difficult for a Consumer to go back to the site, if after leaving the restaurant, they wanted to see the menu or web site again. Generally, they could only revisit the menu or web site if they had access to the QR Code to scan again. In our model, every QR Code is directed to a schedule or event which can be saved to a list. Consequently, in the future, a consumer accesses the schedule is from their saved schedule list and there is never a need to have access to the original QR Code to retrieve or view a schedule or event.

Publishers want Consumers to have easy, up to date access to their events schedule. Since attendance at events is tied to more people knowing their schedule, Publishers want the ability to share and have people save their schedule as quickly and easily as possible. Their goal is to increase the number of people who view their accurate schedule with the hope more views increase attendance at their events.

Consumers on the other hand want to be able to quickly and easily save, retrieve, view and integrate their favorite schedules. Today, a Consumer interested in saving and integrating a dozen schedules from different entities would have a time-consuming task. Of the dozen, some might be printed, others on a web site and still others in a picture on a phone taken of a schedule on a white board. Our process provides a simple and consistent process for saving, retrieving, viewing and integrating schedules.

Consumers have no “place” for schedules today. There is no single app or folder where I can store my favorite schedule, integrate selected schedules into a single feed for easier viewing and open any single schedule in a single click. Consumers are forced to save schedules to the personal calendar on their phone or desktop. These personal calendars were not optimized for schedule saving, integrating and viewing.

Without a new process and application specifically designed for schedules, a Consumer's personal calendars on a phone or computer becomes the default as the only logical place to save schedules. Consumers may see an “add to calendar” function on some schedules and selecting that option adds the schedule to a listing in the Consumer's personal calendar.

However, personal computers were not designed to accommodate schedules as marketing collateral from a Publisher. There are a few problems. First only some event data is transferred. Certainly, the name of the event, time and date as well as any address transfers. Images associated with the schedule are unlikely to transfer, notes and hyperlinks may not, nor repeat events, which often have different formats. Schedules added to personal calendars only transfer limited event data.

This approach is convenient for Consumers since it leverages their personal calendar. But, given the design point for a personal calendar is to track commitments and for time management, it is not well designed for the Publisher who wants to promote their brand, offer enhanced information along with their events and have their schedule opened in a single action. For this reason, a separate platform specifically designed for schedules incorporating features for both Publishers and Consumers is necessary.

The problems with the current system for Publishers:
No auto-generated QR Codes. Additional steps are necessary to create a QR Code and Link to promote and market their schedule.
Schedules can only be saved by Consumer to their personal calendar where it loses any branding and additional information.
Printed schedules can get out of date and cannot be updated.
Schedules saved to a personal calendar cannot be opened in a single action. The Consumer needs to tell the personal calendar not to show the schedule as an overlay but top open this schedule “only”. Going back to where they were before opening a single schedule can take time.
No link back to a complete schedule when events from multiple schedules are integrated. Publishers want Consumers who show an interest in an event to see more events from the same Publisher. This increases the visibility and ultimately attendance at the Publishers events.
Schedules that are added to personal calendars do not allow for understanding engagement, QR Code scanning and the number of Consumers who have saved their schedule.
Creating aggregated marketing schedules of events from multiple independent “source” schedules “rolled up” into a single schedule is either not possible or very time consuming.

The solution is a new platform and the subject of this non-provisional patent application. This platform was designed as an end-to-end process to bring together Publishers and Consumer of schedules and events and address the issues outlined above.

The solution for Publishers:
QR Codes and Links to the schedule are automatically generated and immediately available to market and promote the schedule.
All schedules can be saved to a list eliminating the need to have access to the QR Code or link in the future for Consumers to revisit the schedule.
Any individual schedule in the list can be open in a single action, click or tap. This makes it much easier to access individual schedules without having to take additional steps.
Events from multiple schedules can be integrated in to a single timeline. This makes it easier for the consumer to view multiple schedules together.
Thumbnail images on events link back to the original schedule. This increases the visibility of all schedules as events presented in an integrated way from a timeline or from search results links back to the original schedule the event came from.
This new platform is the only one where a Publisher can create a schedule, get an auto-generated QR Code and Link, immediately share their schedule knowing the Consumer will be able to easily save it into a listing which, when viewed, preserves their brand imaging associated with the schedule.
Traditional personal calendars do not provide the ability to track the usage on a per schedule basis
Using a dashboard, Publishers can track the number of people who have scanned and saved a specific schedule in addition to other user engagement metrics.

Users can publish auto-populated and updated aggregated schedules of events by selecting which schedules and events to include in the aggregated schedule. When the selected schedules are populated, these events automatically become part of the aggregate schedule. This eliminates or greatly reduces the need to manually populate an aggregated schedule of events.

The problem with the current system for Consumers:
There is no “place” for saving schedules. Currently schedules are saved in personal calendars but personal calendars are not designed for simple access to schedules. These calendars are for personal commitments and time management and people generally do not want to see schedule events they have not committed to on their calendar.
Retrieving, viewing and returning to original state of your personal calendar is cumbersome. Generally, to open a single schedule a user must click on options for a particular schedule and answer if they want to see “this schedule only”, If selected, once viewed, returning to the original state requires the user to recreate it.
Consumers find it difficult to track all their favorite schedules at once. There is no ability to have a schedule listing and then just click on any one of them to view or integrate them into a timeline and view all at once.
Consumers have no easy way to save a printed schedule or one on a white board.
Consumers have no ability to save a schedule on the spot when in a venue or from a program at a game. Today, this might involve taking a picture of a schedule but it is static image and the content cannot be updated or integrated with other schedules.
Consumers have no ability to access the complete schedule from an integrated listing of events from multiple schedules. This visibility to the schedule would be good for both the Publisher and the Consumer.

The solution for Consumers:
Schedules can be saved immediately at an establishment by scanning the QR Code on available collateral and hitting the save icon.
All schedules are saved to a saved schedules list and are available from the navigation bar in a single action Opening any schedule from the list if fast and easy and can be done in a single action.
Schedules can be individually selected to be integrated into a timeline so many schedules can be viewed at once.
From an integrated listing of events from a timeline or search results, a Consumer may tap or click on a thumbnail associated with the event which links back to complete schedule.
Printed schedules with QR Codes can be instantly saved. The saved digital schedule is always up to date based on Publisher updates.

While there are a potentially endless number of solutions, the result of implementing any given solution is uncertain due to the inherently difficult and complex nature of the aforementioned technical problems. Therefore, what is needed is a system and method for creating, sharing, curating, integrating, viewing, and analyzing event schedules having all of the further described features and advantages.

### SUMMARY OF THE INVENTION

The subject matter of this application may involve, in some cases, interrelated products, alternative solutions to a particular problem, and/or a plurality of different uses of a single system or article.

The filing describes an embodiment of the structure of the disclosed platform. Publishers and consumers access the platform via a client application which can be a web-hosted application or a mobile phone application or both. A consumer can access the platform in one of two ways, either unauthenticated or authenticated. If unauthenticated, the consumer is limited to reading schedules associated with a QR code or link. When authenticated, the consumer may also save schedules to a personal list and configure which schedules are viewable in their timeline. A publisher must be authenticated to generate or modify schedules on the platform.

To authenticate to the platform, a user must have previously registered for an account. Accounts can be created on the platform by providing a unique contact email address or phone number associated with the user. A user successfully authenticates to the platform by means of single factor or multi-factor authentication which establishes a secure connection to the platform for subsequent interactions.

The application client communicates with the system platform over a public network such as the Internet and requests to create, update, view or remove schedules or to organize which and how schedules should be presented.

An authenticated publisher can create one or more schedules, each of which is associated with a unique identifier in the form of a QR code or traversable link at the time of creation. The QR code and link association with a schedule remains for the lifetime of the schedule's existence. The publisher can curate each schedule's content and presentation using the client application. Subsequently, a consumer can arbitrarily use the client application to scan this QR code or click on the link to access the associated schedule details stored in the platform. A separate QR Code and Link are created to track viral sharing of the schedule.

In one aspect a scheduling system is disclosed. In this aspect, the scheduling system comprises a computer housing a processor and a memory, and the memory stores instructions for execution by the processor. The scheduling system also comprises a graphical user interface, a user input device, and a service infrastructure connected to the computer. The computer and the service infrastructure are connected over a public network, and the scheduling system is operable to create a schedule and automatically generate a unique matrix code and link for the schedule.

In another aspect a method for creating and promoting schedules is disclosed. In this aspect, the method is carried out by a computer housing a processor and a memory, and the memory stores instructions for execution by the processor. Upon execution, the processor is operable to perform the following steps: (1) displaying at least one of a scheduling application or a scheduling website on a user interface; (2) receiving credentials for an account creations; (3) verifying a user identity and creating the account; (4) displaying a template for creating a schedule on the user interface; (5) receiving inputs on the template to create the schedule; and (6) creating the schedule.

These aspects of the invention are not meant to be exclusive and other features, aspects, and advantages of the present invention will be readily apparent to those of ordinary skill in the art when read in conjunction with the following description, appended claims, and accompanying drawings.

### BRIEF DESCRIPTION OF DRAWINGS

FIG. 1 shows the physical elements of an embodiment of the structure of the disclosed platform.

FIG. 2 shows the flow for publishers in the application.

FIG. 3 shows the flow for consumers and aggregate Publishers in the application.

FIG. 4 shows a process overview chart for the application.

FIG. 5 shows an embodiment of a user interface display for an account creation process carried out by the disclosed system.

FIG. 6 shows an embodiment of a user interface display for a verification process carried out by the disclosed system.

FIG. 7a shows an embodiment of a user interface display for a schedule creation process carried out by the disclosed system.

FIG. 7b shows an embodiment of a user interface display for an event editing process carried out by the disclosed system.

FIG. 8 shows an embodiment of a user interface display for a matrix code and link generation process carried out by the disclosed system.

FIG. 9 shows an embodiment of a user interface display for a marketing process carried out by the disclosed system.

FIG. 10 shows an embodiment of several user interface displays for a schedule saving process carried out by the disclosed system.

FIG. 11 shows an embodiment of a user interface display for two alternate single action access processes carried out by the disclosed system.

FIG. 12 shows an embodiment of a user interface display for the process of adding a saved schedule to a timeline.

FIG. 13 shows an embodiment of several user interface displays for the process of viewing a saved schedule in the timeline.

FIG. 14 shows an embodiment of a user interface display for the dashboard access process carried out by the disclosed system.

FIG. 15 shows a user interface display for one embodiment of the disclosed application or website.

FIG. 16 shows one embodiment of a hybrid user interface simultaneously displaying both the disclosed website and an external marketing website.

### DETAILED DESCRIPTION OF THE INVENTION

The detailed description set forth below in connection with the appended drawings is intended as a description of presently preferred embodiments of the invention and does not represent the only forms in which the present disclosure may be constructed and/or utilized. The description sets forth the functions and/or the sequence of steps for constructing and operating the invention in connection with the illustrated embodiments.

A unified process and methods to create, share, curate, integrate, view and analyze schedules of events in a single platform bringing together publishers and consumers of schedules content. The images show the inventive process and the process steps using images from the application.

### Introduction

Many types of people and entities create and share public schedules. These include, but are not limited to, performers, religious institutions, schools, libraries, towns and communities, clubs, teams, etc.

The problem is no application has been specifically designed for schedules. The result has been a very inefficient and ineffective process of creating, sharing, saving, integrating and viewing schedules.

Publishers who want to integrate their schedule along with others are left with limited options and must sacrifice the marketing value of their branding when integrating their schedule on personal calendars. Personal calendars capture event detail but do not allow schedule branding images to be imported. Marketing schedules with images to promote their brand loses much of their marketing appeal when no image is captured when importing events into a personal calendar. This application allows Publishers to share and promote an events schedule with both the event detail and the associated branding.

Schedules can be saved to a personal calendar and added to the list of saved schedules/calendars where the user may integrate multiple calendars as an overlay to their personal calendar data list of schedules and allow for the events to be integrated. This process is cumbersome and involves overlaying the events onto a personal calendar. The process by which a schedule can be viewed discretely has multiple steps no personal calendar offers single click access to the full schedule from a schedule list or an integrated timeline.

Schedules are designed to be promoted. Getting maximum exposure is the best way to improve the attendance of events. QR Codes and links to a schedule are important means of schedule promotion however; there are currently additional steps necessary to generate a QR Code and link for a schedule. No application generates these marketing tools as a by-product of schedule creation. Generating a QR Code and link would then require additional steps and outside resources. This application auto-generates a QR Code and Link which the Publisher can immediately download and use for marketing and promotion. Our QR Codes and links all point to schedules which can be saved to a listing for future access to the schedule. This process eliminates the need to rescan the QR Code to access the schedule. Part of getting maximum exposure for events and schedules is by association, user can integrate their favorite schedules into a timeline which eliminates the need to open schedules individually and increases exposure for events and schedules which are integrated.

Publishers would also like to know how successful their campaigns are for promoting the schedule. In this design, there is a dashboard which tracks user engagement on a per schedule basis. With this information, Publishers can know if their efforts to promote the schedule have been successful.

This patent is designed to protect the improved and unified process and methods of bringing Publishers and Consumers of schedules together. This filing shows the journey of how the Publisher creates Schedule P1-1A and the Platform auto-generates a QR Code and Link for the schedule. The Publisher downloads the QR Code and Link and uses them in marketing Schedule P1-1A. The QR Code/link becomes the “connection” between the Publisher, schedule and Consumer. Once the Publisher has marketed their schedule with the QR Code, the dashboard allows them to analyze how many people scanned and saved schedule and other information.

Consumer is interested in Schedule P1-1A and scans the QR Code with their mobile phone, views the schedule and decides to save it to their Saved Schedule List. Consumer then decides to integrate the events from Schedule P1-1A into their timeline. The timeline is an effective way to see many schedules all at one time. When reviewing the timeline, Consumer may tap on any event thumbnail image to view the complete schedule. This would also be true where search results are a listing of events from multiple schedules.

This process dramatically increases the visibility of Schedule P1-1A. First, the schedule can be publicly marketed using the QR Code. Second, all schedules can be saved with a single action eliminating the need to scan again to access the schedule. Third, schedules incorporate a tracking copy of the QR Code allowing anyone to share the schedule. Fourth, Consumers now have a place for saved schedules. This help increase exposure when a Consumer looks for any schedule, they are looking at all in their Saved Schedule List. Fifth, schedules and events can be integrated into a single timeline increasing visibility for all. Sixth, event thumbnails provide a link back to the complete schedule from which the event came. When events from multiple schedules are integrated, the thumbnail is an identifier on what schedule it came from. Clicking on the thumbnail will take the Consumer to the full branded schedule. Seventh, Publishers can know how effective their marketing and promotion campaign for their schedule has been by accessing their dashboard. Dashboard data is an important piece of the feedback loop to improve schedule visibility and event attendance.

These steps taken together significantly increase the exposure of schedules. When schedules and events are shown together, Consumers will be exposed to schedules they were unaware of but found as a byproduct of looking for other schedules or events.

This process starts with the application being available on the Internet. The application may be web based and/or available in an app store.

There are four constituents for this application; Publisher, Consumer, Platform and External Marketing.
Publisher: A person who wants to create, publish and share a schedule of events.
Consumer: People who want to find, save, curate and view schedules. Consumers can be Members and have an Account or non-Members. Only Members can save Schedules and have Timelines.
Platform: An application providing the functionality to bring together the publisher and consumer of schedules in an optimized manner.
External Marketers: People who partner with Publishers to create marketing material promoting schedules. These promotions would likely involve the use of the QR Code and Link generated by the Platform.

The steps outlined below are a detailed explanation on how to deliver a simplified value chain from creation to consumption of schedules from Publishers to Consumers. In this case, we are following how a Publisher P1 creates an account; builds, publishes and promotes Schedule P1-1A. This example shows how Consumer C1 scans a QR Code for Schedule P1-1A to view, save to their Saved Schedules List and then add Schedule P1-1A to their Timeline. From a Schedule P1-1A event in the Timeline, Consumer C1 can tap on the thumbnail to access the full Schedule P1-1A. Publisher P1 accesses their dashboard to review user engagement and sees that Schedule P1-1A has been scanned and saved. This is a new process and we are seeking patents to protect unique aspects of our implementation of this value chain.

Although there are specific references to a “tap” it generally refers to any action taken to notify the system to take an action. It may also be a “click or voice command”. References to any “icon” should be interpreted as any space in an application that has a graphic UI form which can be tapped or clicked to tell the system to take a certain action. The graphical UI form of the icon is not important to the patent. Changes to icons to designate a different state of the icon can be varied although for simplicity and as an example, we have made choices for this application.

### Physical System

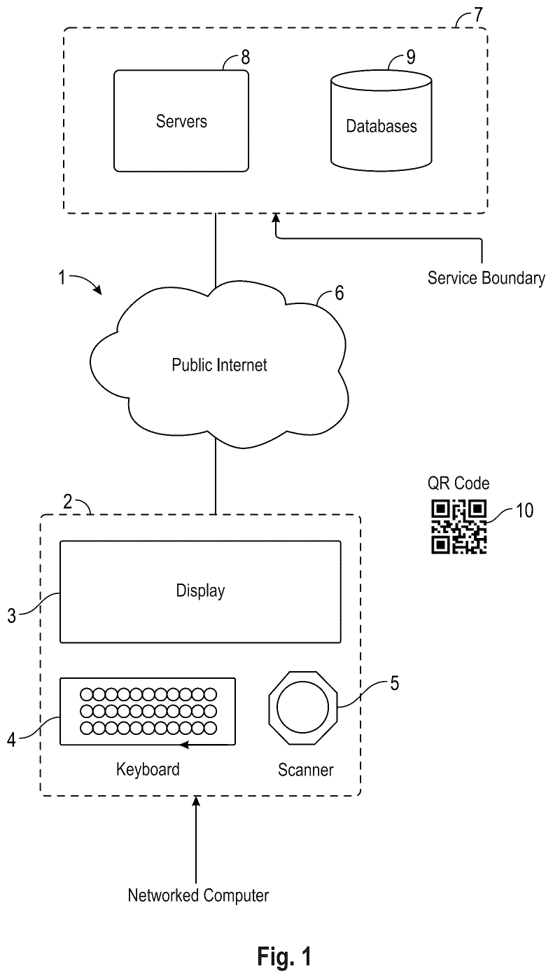

FIG. 1 shows a physical diagram of an embodiment of the system. This physical diagram depicts the computing machinery that constitutes the scheduling system 1. A canonical networked computer 2 (the client) can be a cellular wireless mobile device or any networked computer having an input device 4 (physical or virtual keyboard, mouse), scanning camera 5 (for accessing the application through the QR Code 10) and display screen 3. The service boundary 7 constitutes the network boundary around the service infrastructure (the service) implementing the scheduling service. The client is connected to the service over a public network such as the Internet 6. The service presents a public digital interface allowing clients to create schedules to be stored in the service and to retrieve schedules already stored in the service by means of a unique link or QR code 10.

In this embodiment, the system 1 includes a non-transitory computer readable medium or memory, which contains instructions allowing and instructing at least one central processing unit (the “CPU” or “processor”) to carry out the steps required during performance of the computerized method described herein. The memory and the processor may be housed within the computer 2, or may be accessible through an electronic communication system, such as the Internet 6.

The computer 2 facilitates user access to the system 1 by providing a graphical user interface or display screen 3 through which users may interact with a website or an application embodying the scheduling system. Users, such as consumers or publishers, may interact with the system through at least one input device 7. The term “input device” is meant to encompass any hardware or components designed to facilitate user interaction with a computerized system, including, but not limited to, a mouse, keyboard, touchscreens, and the like. The service infrastructure within the service boundary 7 includes one or more servers 8 and one or more databases 9. The server (s) 8 and database (s) 9 store the necessary files and information that are required for user operation of the scheduling system 1. This information may also be stored, entirely or in part, on the memory of the computer 2.

### Publisher Main Logical Service Interactions

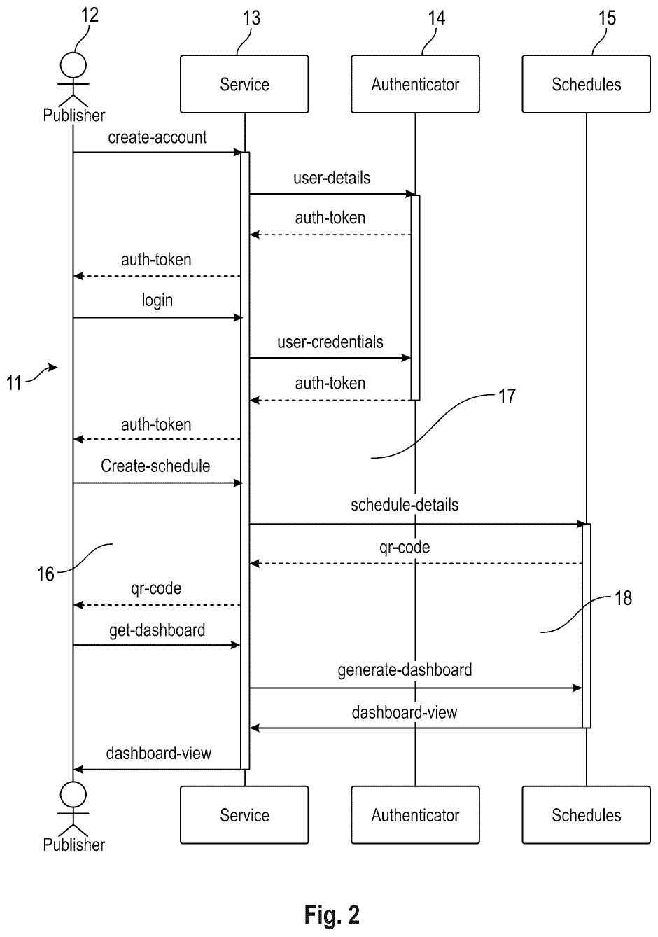

A publisher is a person or entity who creates, updates and monitors their schedules in the service. They are provided an auto-generated QR Code 10 to assist in the marketing and promotion of their schedules. FIG. 2 shows the main logical service interactions 11 carried out by a publisher 12 with the system.

It should be expressly understood that the computer 2 of the publisher 12 is associated with and carries out most, if not all, of the main logical service interactions 11. For example, in this embodiment, the service interactions 11 are split into three categories: service 13, authenticator 14, and schedules 15. The service interactions 16 for a publisher 12 include, but are not limited to, creating an account, logging in, creating a schedule, and accessing and viewing a dashboard. The authenticator interactions 17 include, but are not limited to, user details, user credentials, schedule details, dashboard generation and display, and authentication tokens. Finally, the scheduling interactions 18 include, but are not limited to, schedule details, dashboard generation and display, and QR code generation.

### Consumer Main Logical Service Interactions

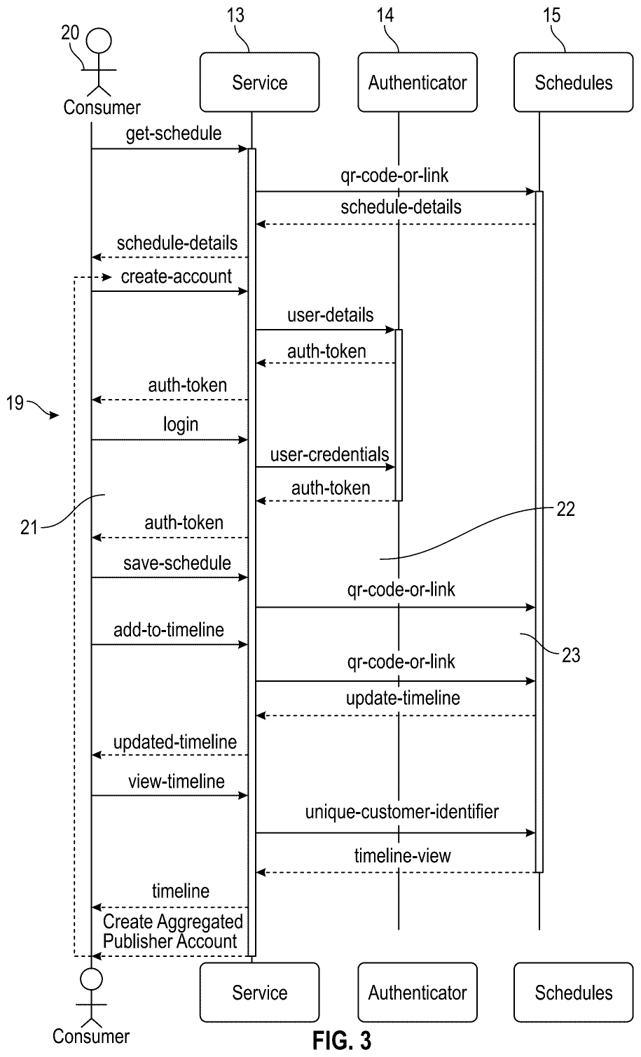

A consumer is a person or entity who benefits from information stored in the schedules in the service. FIG. 3 shows the main logical service interactions 19 carried out by a consumer 20.

It should be expressly understood that the computer 2 of the consumer 20 is associated with and carries out most, if not all, of the main logical service interactions 19. Similar to the interactions 11 for the publisher 12, the service interactions 19 for the consumer 20 are split into three categories: service 13, authenticator 14, and schedules 15. The service interactions 21 for the consumer 20 include, but are not limited to, creating an account, logging in, accessing and saving a schedule, adding the schedule to a timeline, and viewing the timeline. Consumer may have an option to create an aggregated Publisher account to publish and promote their aggregated timeline. This is largely the same process currently envisioned for creating the Publisher account in FIG. 2. The authenticator interactions 22 include, but are not limited to, user details, user credentials, using a QR code or schedule link, using a unique customer identifier, and authentication tokens. Finally, the scheduling interactions 23 include, but are not limited to, schedule details, updating the timeline, and timeline display.

### Process Overview

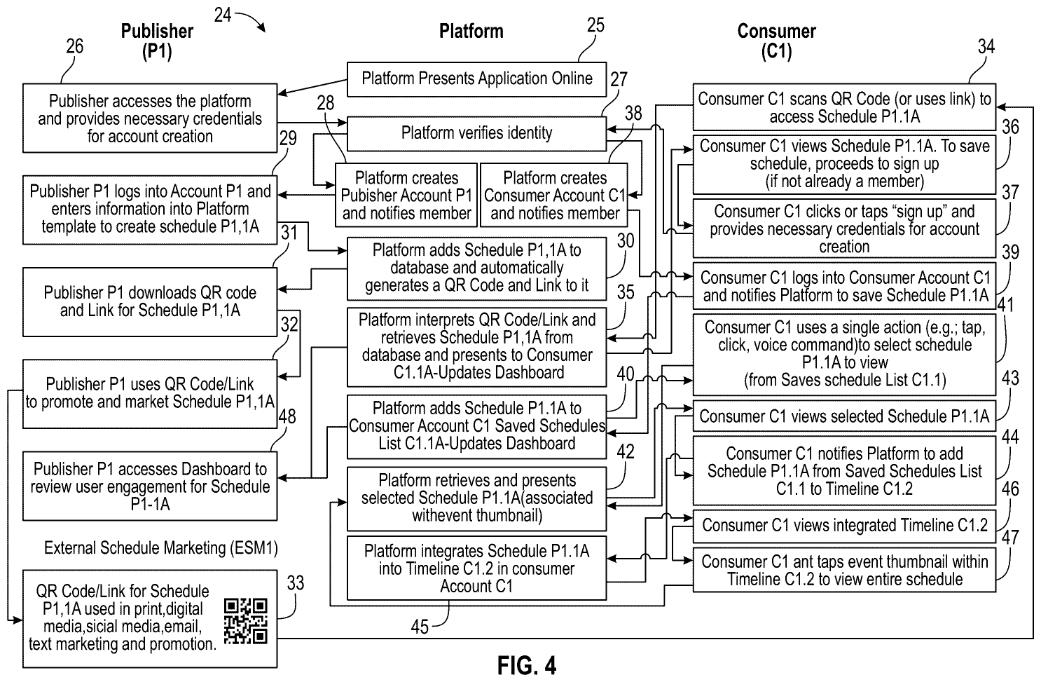

FIG. 4 shows a process overview chart 24 for the application. In this embodiment, the process carried out by the disclosed system begins with the display of the scheduling application or scheduling website 25. If an account has not yet been created, a publisher then accesses the platform and provides necessary credentials for account creation 26. After the platform verifies the publisher's identity 27, the platform creates a publisher account and notifies the publisher 28.

After account creation, the publisher may log into the account and enters information in a platform template for creating a schedule 29. Once the schedule is complete, the platform is operable to save the schedule on a database and automatically generate a QR code (s) and link (s) for the schedule 30. The Publisher QR code and link are displayed on the user interface of the publisher's computer, and the publisher then downloads the QR code and link 31 to promote and market the schedule 32.

As illustrated in the process overview chart 24, consumer interaction with the platform begins after the publisher has begun external schedule marketing. In this embodiment, and still referring to FIG. 4, the QR code and/or the link for a specific schedule may be used in any print, digital, or social media, including, text email, marketing, and similar promotions 33. Depending on what type of computer a consumer is using, the consumer either scans the QR code or uses the link to access the schedule 34. The platform then interprets the QR code and/or the link and retrieves the schedule from the database and presents it to the consumer 35. At the same time the platform also simultaneously updates the publisher's dashboard 35.

After the schedule is retrieved, the consumer can save the schedule 36. If the consumer is not already signed up, the consumer will need to create an account 36 before the schedule can be saved. The consumer may be prompted to sign up upon interacting with the QR code and/or the link by clicking or tapping a “sign up” button and providing the necessary credentials for account creation 37. In response to this action, the platform verifies the consumer's identity 27 and creates an account 38. After the consumer is notified of the successful account creation 38, the consumer may log into the account, prompting the platform to save the schedule 39 by adding the schedule to a list of saved schedules for the consumer account 40. The platform also simultaneously updates the publisher's dashboard 40.

Once saved, the consumer can access the schedule by using a single action to select the schedule 41. In response to the single action from the consumer (e.g., a tap, a click, a voice command, etc.), the platform retrieves and presents the selected schedule on the display screen of the consumer's computer 42, where the consumer is able to view the selected schedule 43. After viewing the selected schedule, the consumer may prompt the platform to add the schedule to a timeline 44, and the platform will respond by integrating the schedule into the timeline 45. The consumer may then view the integrated timeline 46 and tap an event thumbnail within the timeline. In response the platform retrieves and presents the selected schedule 42, which allows the consumer to view the entire schedule 47.

When a consumer interacts with a QR code and/or a link for a specific schedule or otherwise saves or interacts with a schedule, the platform is operable to update the publisher's dashboard information. This allows a publisher to access the dashboard and review user engagement for the schedule 48.

In some embodiments, the platform is operable to generate two custom versions of QR codes and links for each schedule, one for the owner/publisher of a schedule and the other for the consumer. This allows the platform to track publisher-to-consumer marketing separately from “viral” consumer-to-consumer sharing. These separate QR codes and links may be tracked separately by the platform and displayed as separate metrics on the dashboard.

### Step #1: Person Accesses Application and Fills in Template for Account Creation

The process begins when a person wanting to create a schedule of events (Potential Publisher) accesses the application.

Step #1a: Person who wants to be a Publisher accesses the application on the web or as an app on mobile devices available in the app store. If from web, Platform presents web application.

Step #1b: Person, if using the web, clicks “sign up” button to create an account.

Step #1c: Platform presents to person, an Application form.

Step #1d: Person fills out Application form and hits submit. Form includes an email address.

Step #le: Platform receives the completed form and generates a verification code and sends it to the email address submitted on the Application form. Platform presents Person with a form which asks the Publisher 1 to check email and enter verification code in provided space.

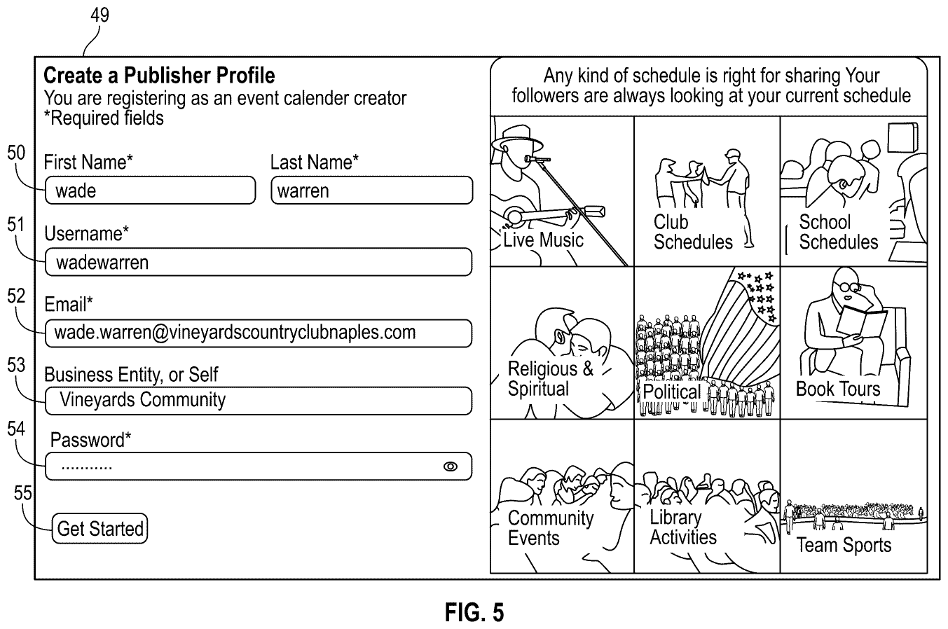

FIG. 5 shows an embodiment of a user interface display 49 for the aforementioned account creation process carried out by the platform. In this embodiment, the application form displayed on the user interface 49 includes fields for a first and last name 50, a username 51, an email 52, an associated business name 53 (if applicable), and a password 54. After filling out these field, the “Get Started” icon 55 can be pressed, which causes the platform to display a different user interface.

### Step #2: Person Verifies Email

Step #2a: Person checks the email associated with submitted application and takes the verification code and enters it into the space provided in the application. Person hits “verify” or “submit”.

Step #2b: Platform receives the verification code and compares it to the code sent to Person. If the codes match then the Platform creates Publisher account P1 and notifies Publisher 1 that an account has been created.

Once Publisher P1 has a verified account they are able to create, publish and promote schedules.

Step #2c: Publisher P1 logs into their account.

Step #2d: Publisher P1 clicks to create a schedule.

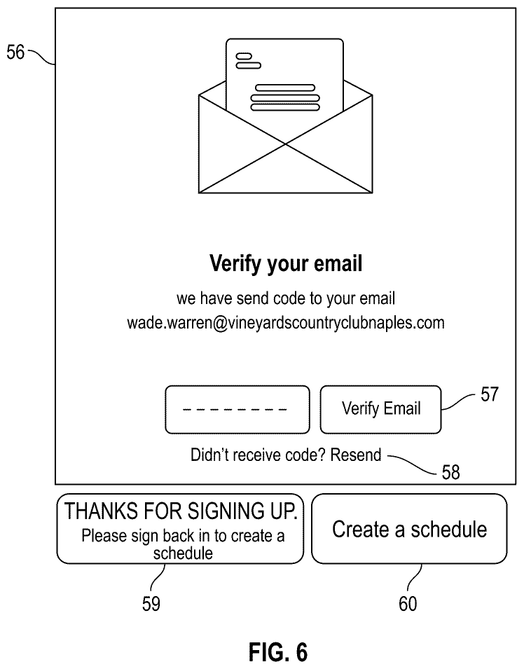

FIG. 6 shows an embodiment of a user interface display 56 for the aforementioned verification process carried out by the platform. In this embodiment, the user interface 56 displays a field for entering a code to verify an email 57. A code can be requested by clicking the “Resend” hyperlink 58. Once the email is verified and the account is successfully created, the user interface may display a message or icon prompting the user to sign in 59 and/or create a schedule 60.

### Step #3: Publisher P1 Fills Out Template to Create Schedule P1.1A

Step #3a: Platform presents to Publisher P1 a template to create a schedule.

Step #3b: Publisher P1 fills out the template with profile information about their schedule.

Step #3c: Publisher P1 hits “next” to proceed.

Step #3d: Platform creates a schedule profile for Schedule P1-1A.

Schedules are comprised of two primary parts, profile and events.

Step #3e: Platform presents Publisher P1 with template to create events for Schedule P1-1A.

Step #3f: Publisher P1 adds information to create events for Schedule P1-1A.

Step #3g: Publisher P1 can either save or publish Schedule P1-1A. Publisher 1 hits “Publish” to publish Schedule P1-1A

Step #3h: Platform receives the events for Schedule P1-1A profile and schedule is added to Publisher P1 Account. Schedule P1-1A is now available to Consumers online.

Step #3i: Platform automatically generates a QR Code and Link for Schedule P1-1A

Step #3j: Platform presents to Publisher P1 a notification that Schedule P1-1A has been created and QR Codes and Links can be downloaded to promote and market Schedule P1-1A. Schedule is added to the Publisher dashboard.

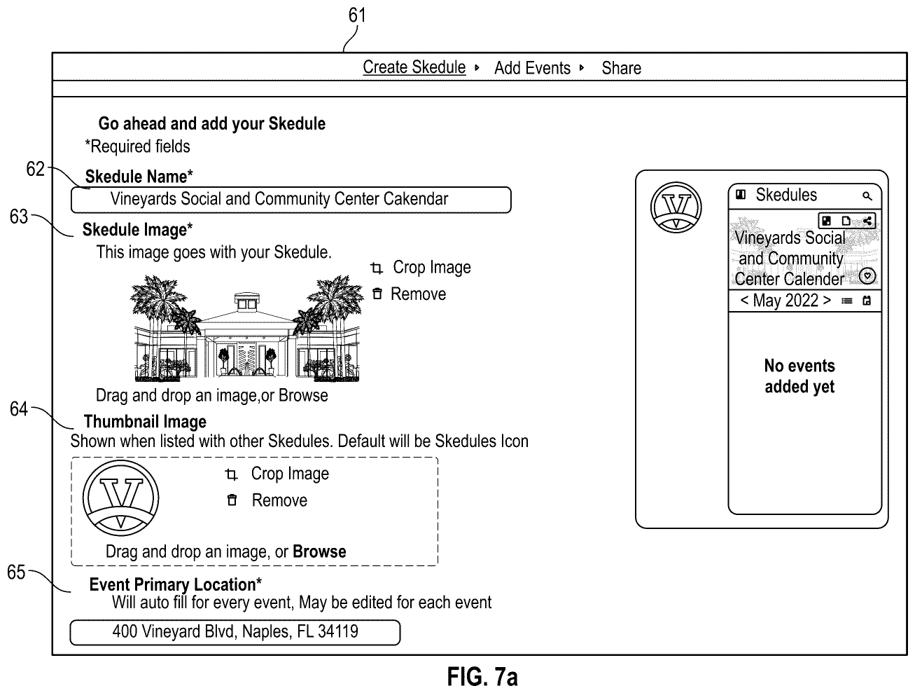

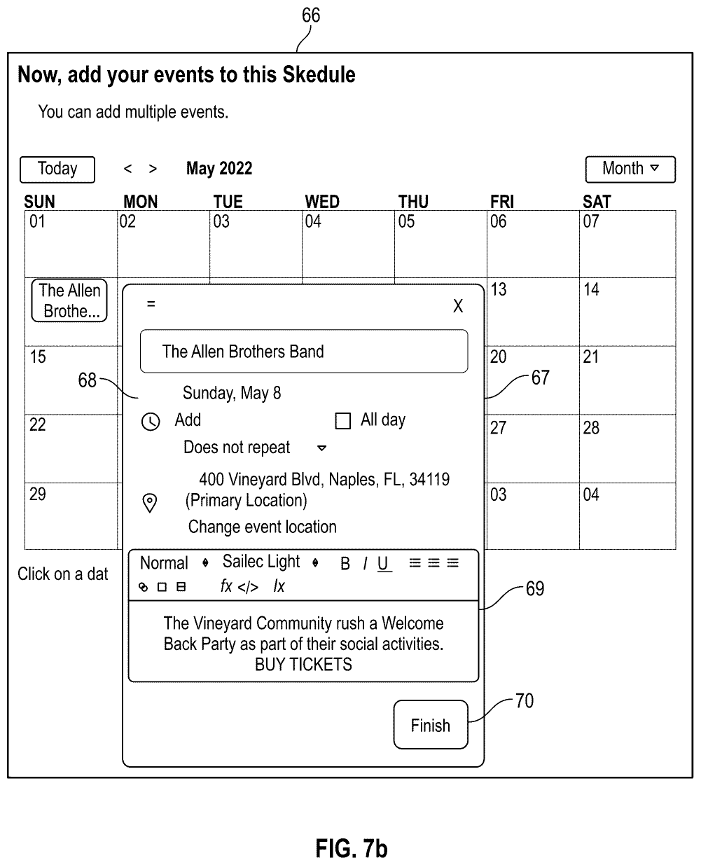

FIG. 7a shows an embodiment of a user interface display 61 for the aforementioned schedule creation process carried out by the platform. In this embodiment, the user interface 61 displays fields for entering a schedule name 62 and uploading a schedule image 63. The user interface 61 also displays fields for entering other information that may be necessary for schedule creation, including, but not limited to, uploading a thumbnail image 64, and entering an event location 65.

Schedule Profile information includes the name of the schedule; business, school or band, along with a marketing image which is shown when the schedule is viewed. Publisher may also include a thumbnail image to identify the schedule when it is shown in a listing or when events are integrated along with other schedules in a Timeline or search results. Additional information such as the address of the venue, a short description of the schedule, contact information and social media links can also be added.

Events are the content of a schedule and often change frequently. Events information includes event name, time and date, address (participation method real or virtual) and may include interest tags, notes and a description of the event. Links to offsite web pages for ticket sales, reservations or just additional information can also be added.

FIG. 7b shows an embodiment of a user interface display 66 for the aforementioned event editing process carried out by the platform. In this embodiment, the user interface 66 displays an event profile overlay 67. The event profile includes fields containing event information 68 and a field for editing the event description 69. Once the schedule and event profiles are completed, the displayed “Finish” button 70 may be selected by a user, which prompts the platform to generate a QR code and link for the schedule.

QR Codes can be downloaded in multiple formats. These QR Codes and Links can be used directly by the Publisher to promote and market the schedule or sent to External Marketing partners to create collateral and promotional material for Schedule P1-1A to generate traffic and interest in the schedule.

### Step #4: Publisher P1 Downloads QR Code and Link

Step #4a: Publisher P1 views the invitation to download the QR Code in multiple formats along with a link to Schedule P1-1A.

Step #4b: Publisher P1 clicks “Download Code” and is presented with several popular formats for the downloaded file.

Step #4c: Platform receives the download request and enables downloads to Publisher P1 in their desired formats.

Step #4d: Publisher P1 downloads file and link.

Step #4e: This step is optional but at this time Publisher P1 may use link or QR Code to market immediately on social media, email and text links presented to simplify the sharing of Schedule P1-1A.

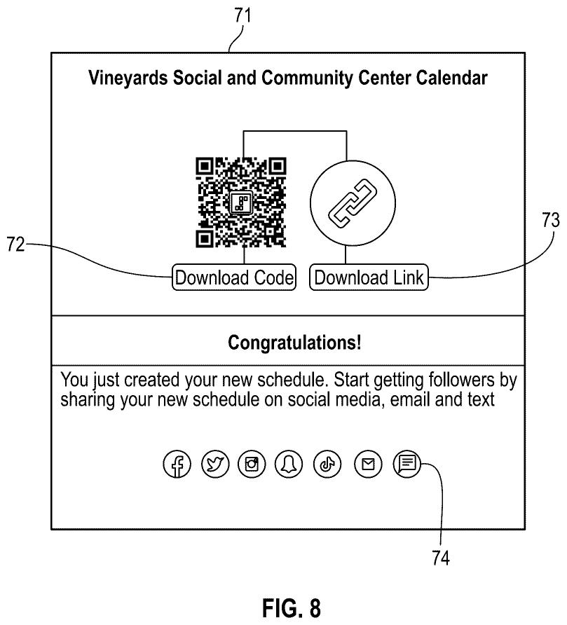

FIG. 8 shows an embodiment of a user interface display 71 for the aforementioned matrix code and link generation process carried out by the platform. In this embodiment, the user interface 71 displays buttons for a user to download a matrix code 72 or a link 73 for the schedule. Clickable social media icons 74 are also displayed on the bottom of the user interface 71. These icons 74 may be hyperlinks to social media websites, allowing a publisher-user to efficiently proceed to market their schedule to consumers.

It is important to have both a QR Code and Link for a schedule as each has different usages. A QR Code may be used for a TV screen or print whereas a link may be better in an email or text. Both are provided to allow more flexibility in promoting a schedule.

In addition, creating and producing a marking piece using the QR Code may be more time consuming than using the Link. A Link would be a better option when sharing digitally in email and test. It is worth note that when people are reading the promotion on their mobile device scanning a QR Code is not possible with the phone camera being used to read the email. To solve this, the process incorporates “clickable” QR Codes which can be scanned or clicked on as a link to access Schedule P1-1A.

### Step #5: Publisher P1 Uses Schedule P1-1A QR Code to Market Schedule

Step #5a: Publisher P1 retrieves the downloaded QR Code for Schedule P1-1A and creates a promotion piece for the Vineyards summer schedule. The downloaded QR Code is included in the marketing piece. A statement similar to “Scan to take this schedule with you” or “Scan and save this schedule” can accompany the QR Code.

Step #5b: Publisher P1 distributes the marketing piece created with the downloaded Code in places Consumers can access and scan the QR Code.

Publisher P1 downloads the QR Code and Link for schedule P1-1A and uses it to promote the schedule. Publisher P1 may create the marketing piece themselves or contact an External Marketing partner to incorporate the QR Code or link into marketing promotions.

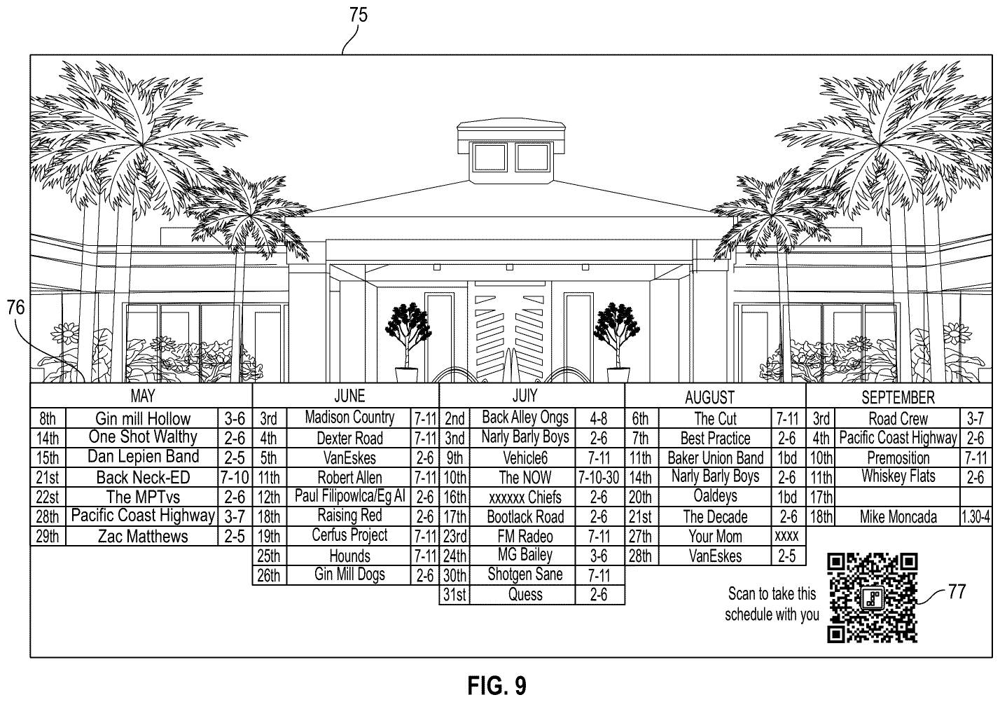

FIG. 9 shows an embodiment of a printed marketing piece or a user interface display 75 for the aforementioned marketing process. In this embodiment, the printed marketing piece and/or the user interface 75 shows a schedule 76 including a listing of events by date. Also shown is a scannable and/or downloadable matrix code 77 for the schedule 76. In an embodiment where the marketing is carried out using the platform, the user interface 75 displays the matrix code. A consumer's camera may be used to scan or download matrix codes shown in digital and print media alike.

Publishers increase the visibility and attendance of events by promoting their schedule. Printed schedules are often out of date. There is no easy way to update an outdated schedule that has been printed and distributed. This problem is mitigated when using a QR Code that points to an online schedule. QR Code for a schedule never changes giving the Publisher confidence in using it in printed material and exposing the Consumer to the latest version of their schedule. When a Consumer scans a QR Code the version of the schedule viewed is the most accurate. Publishers no longer have to worry about outdated printed schedules.

The Platform also allows every schedule to be easily saved by the Consumer. Schedules can be added to a Saved Schedules List and then incorporated into a personalized Timeline. Consumer can view any schedule from the Saved Schedule List in a single action, tap, click or voice command. This process is the fastest and easiest way to save and view schedules.

### Step #6: Consumer C1 Scans, Views and Taps to Save Schedule P1-1A to Saved Schedules List

Step #6a: Consumer C1 points their mobile camera toward the QR Code for Schedule P1-1A. QR Code is read by the camera and data is sent to the Platform.

Step #6b: The Platform recognizes QR Code for Schedule P1-1A and retrieves the schedule and presents Schedule P1-1A to Consumer C1 to view on their mobile phone. This process is generally the same for a Link to Schedule P1-1A. Desktop consumers generally find Links easier to use as is simplifies the process without the need to pull out their mobile phone scanner.

Step #6c: Consumer C1 views the Schedule P1-1A and decides to save it.

Step #6d: Consumer C1 taps the Schedule P1-1A “heart” or similar icon to designate to the system their interest in saving Schedule P1-1A. Request is sent to the Platform.

Step #6e: Platform receives Consumer C1 request to save Schedule P1-1A. It checks to see if there is a Consumer Account for the user and if they are signed-in. If so, Schedule P1-1A is added to Consumer C1 Saved Schedule List, if there is no account, the Platform sends the user an invitation to create an Account.

Step #6f: Platform adds Schedule P1-1A to Consumer C1 Account Saved Schedules List. Confirmation is sent back to Consumer C1 that the Schedule P1-1A has been saved. The Platform changes the “heart” icon color (in this case blue) to denote Schedule P1-1A is in Consumer C1 Saved Schedules List.

Schedule P1-1A has been added to the Consumer C1 Saved Schedule List. Consumer C1 may now access their Saved Schedules List, their Favorites through the navigation bar.

In the above image and example, red and yellow circles are used to show before (red) and after (yellow) states of the “heart” icon when tapped changes color to demote the state. The state tells the user if a particular schedule is in the Saved Schedule List.

If the icon is in its initial state (red circle), it denotes to this is not the user schedule in their Saved Schedule/Account List. If the icon changes color (yellow circle), it tells the user this schedule is in their Saved Schedule List.

Mobile cameras today generally support scanner functions. If the consumer mobile camera does not support this function, then consumer can download a scanner application from their app store to read QR Codes.

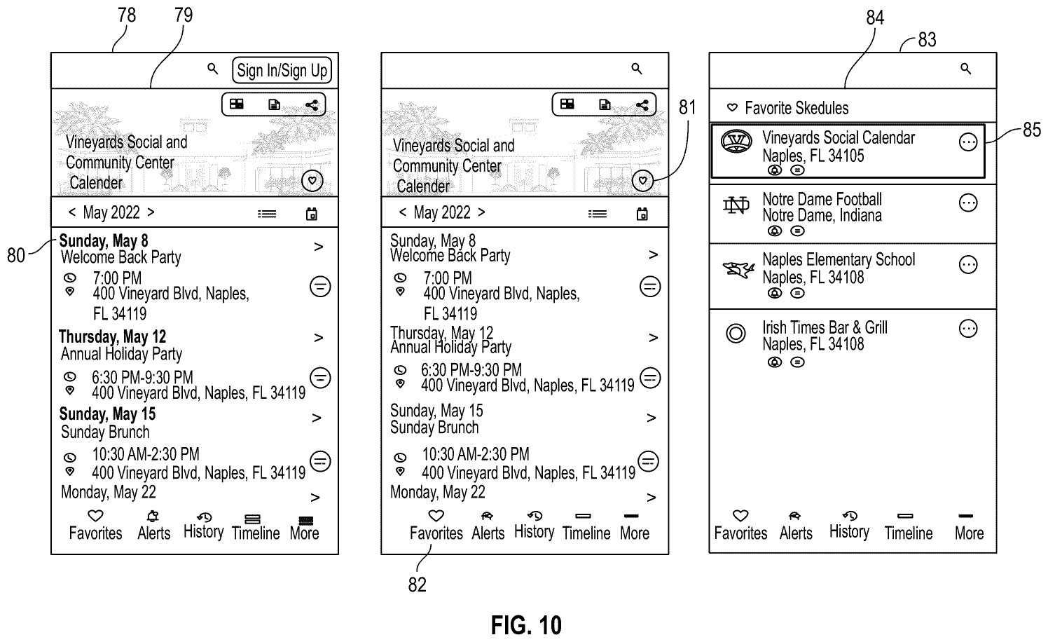

FIG. 10 shows an embodiment of a user interface display 78 for a schedule saving process carried out by the platform. In this embodiment, the user interface 78 displays schedule information 79, including a listing of events and dates for the particular schedule 80. A user may add the schedule to their saved schedules list by tapping the heart icon 81 at the top of the user interface 78.

This embodiment illustrates a technical improvement over known methods. Generally, a QR code directs users to a specific URL. Once the original QR code is lost, users may lose access to the information located at the URL. However, by allowing users to save a schedule with a single (e.g., a click of a button or icon) the information for the schedule is always current, and one never needs the original QR code to return to the schedule.

### Step #7: Consumer C1 Single Action Access to Saved Schedule P1-1A

Step #7a: Consumer C1 taps on “heart” icon 82 in a “navigation bar” to view their Saved Schedules List.

Step #7b: Platform receives request from Consumer C1 and presents Consumer C1 Saved Schedules List.

Step #7c: Consumer C1 taps on Schedule P1-1A (highlighted in red) from the List to view. This single action (tap, click or voice command) from the Consumer C1 sends request to the Platform to view Schedule P1-1A.

Step #7d: Platform receives request and retrieves Schedule P1-1A and presents to Consumer C1.

Step #7e: Consumer C1 views Schedule P1-1A.

FIG. 10 shows an embodiment of a user interface 83 displayed after the consumer-user taps the heart icon 82 in the navigation bar. In this embodiment, the user interface 83 displays a listing of saved schedules 84, including the most recently saved schedule 85.

In the above image, this Consumer has four saved schedules. From this listing, the Consumer may open any schedule in a single click. This ability to create a Saved Schedule List and open any branded schedule from the list in a single action is unique and what we are seeking to patent.

No other platform allows consumers to save a list of schedules, created in a single Platform, where each schedule can be individually viewed using a single action. The efficiency of this process is due to the focus as a schedules platform not a personal calendar application. Specifically, in most embodiments, the platform is operable to display a listing of schedules or events without use of a personal calendar.

Other solutions assume the contents of a saved schedule would be viewed as an overlay to a personal calendar. We assume consumers want to save and view schedules discretely (i.e., not as a personal calendar overlay). This does not preclude integrating several schedules into a single view or feed nor preclude sharing the data with a personal calendar.

In a mobile calendar application, a user may save schedules. The process to see an individual schedule is more cumbersome and requires at least two clicks or taps. The user can often save a schedule to a listing in their mobile phone calendar. In this scenario, the user taps once to access options for the schedule. One of these options may be to see the schedule discretely. There is often wording to effect to “view this schedule alone” to which the user must respond with a second click. Since we are NOT a personal calendar but a schedule application, we open the selected schedule in one action and do not require a second click.

### Step #7-1 Alternate Approach for Using a Single Action to Open an Individual Schedule from a Saved Schedule List in a Personal Calendar Application

Shown above is an alternate implementation for single click access to view a schedule from a Saved Schedule List which may solve the problem as outlined above for a personal calendar application. Our goal is to protect the idea of single action to view a schedule from a saved list of schedules. This would include both a single action from a personal computer list of schedules as well as from a dedicated application and platform as is being discussed in this patent application.

In the illustration and Step #7-1 above, we are showing a typical listing of schedules associated with a personal calendar application. As discussed earlier, generally it would take two clicks from this listing to open a single schedule. In addition, to return to the prior state before the individual schedule was open, the user would have to remember and recreate the schedules they had turned on to be back prior state.

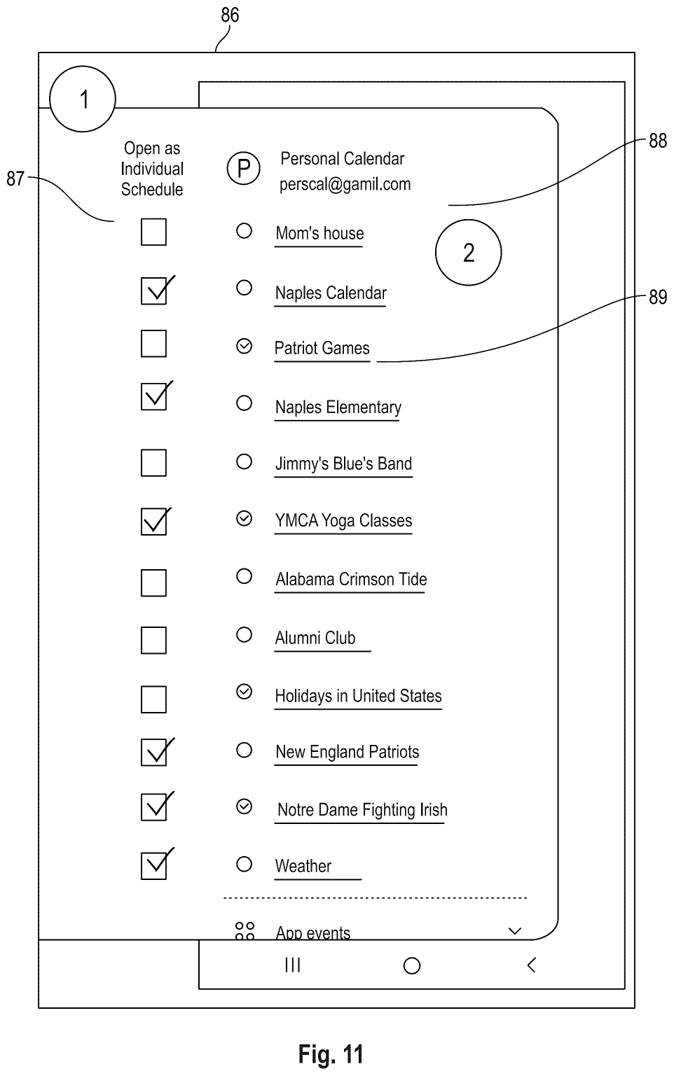

FIG. 11 shows an embodiment of a user interface display 86 for two alternate single action access processes carried out by the platform. These two alternate single action access processes are described further below.

### Step #7-1-1: Alternate 1 for Opening a Single Schedule from a List of Schedules-Identify and Preselect

This red circle labeled “1” in FIG. 11 shows one of the options which may be implemented to allow individual schedules to be open in a single action. The system could be set up to “preselect” those schedules which should be open individually and not as an overlay to the personal calendar 87. In this iteration, the user would check all schedules 88 whose default would be to open as a single schedule and not as an overlay. If the box was not checked, then the schedule could use the current process to overlay selected schedules onto the personal calendar information. To return to the prior state, the user currently has to recreate the schedule and remember which schedules were to be viewed together and select again. This step of recreating can be eliminated by hitting “close” or “X” to close current schedule and show prior calendar as it was prior to opening a single schedule.

Step #7-1-1a: User access the options and selects those schedules they wish to have open in a single action.

Step #7-1-1b: Platform receives the request and stores selected schedule preference in Customer C1 account.

Step #7-1-1c: Consumer clicks on a schedule with a preselected check.

Step #7-1-1d: Platform receives the request and retrieves the schedule selected by consumer and renders it on the Consumer screen.

Step #7-1-le: Consumer views selected schedule.

Step #7-1-1f: Consumer clicks or taps to close selected schedule and is returned to prior state.

### Step #7-1-2 Alternative 2 for Opening a Single Schedule from a List of Schedules-Underline and “Hotlink” to View Schedule

Labeled #2 in the red circle, the personal calendar application would underline each schedule and in a single action, a click or tap on the schedule name 89 would open only that schedule. As above, to return to the prior state hitting “close” or “X” to close current schedule and show prior calendar as it was prior to opening a single schedule.

These two alternatives keep to the spirit of the patent as in each case a select list of schedules is created and the intention of the user is to open and view a single schedule for that list. We have shown how this can be done in a dedicated application or in current personal calendar applications.

Step #7-1-2a: From the Saved Schedule List, Consumer taps or clicks on schedule name they wish to view

Step #7-1-2b: Platform receives the request and retrieves the schedule and renders it to the Consumer screen

Step #7-1-2c: Consumer views the selected schedule

Step #7-1-2d: Customer clicks or taps to close selected schedule and is returned to prior state.

### Step #8: Consumer C1 Adds Schedule P1-1A to the Timeline

Step #8a: Consumer C1 taps icon in Navigation Bar labeled, in this example labeled “Favorites” to view their Saved Schedules List.

Step #8b: Platform interprets this action and retrieves Consumer C1 Saved Schedule List and presents it to the Consumer C1.

Step #8c: Consumer C1 views the Saved Schedule List and taps to open options for Schedule P1-1A. In this example, the options icon is shown as three dots and circled in blue.

Step #8d: Platform interprets the action and presents Consumer C1 an overlay, functionally similar to the one shown in the image above, containing settings for Schedule P1-1A. One of these settings is “Show in Timeline”.

Step #8e: From the overlay screen, Consumer C1 selects to add Schedule P1-1A to their Timeline by setting the toggle button next to “Add to Timeline” in the overlay screen. The UI implementation of this feature is not important to the patent. There are a number of options on how to make a selection to a Timeline.

Step #8f: Consumer C1 hits “Save”.

Step #8g: Platform receives the request, and adds Schedule P1-1A to Consumer C1 Account Timeline and confirms back to Consumer C1 by turning the color of the toggle green.

Step #8h: Platform also changes the color of a Timeline icon associated with this schedule in the Saved Schedule List. From a listing of schedules, it is important to give the consumer an indication on the status of each schedule in their Saved Schedule List. Having an icon change color is one implementation on which schedules are already included in their Timeline. A representative example of an icon is circled in Red in the image above.

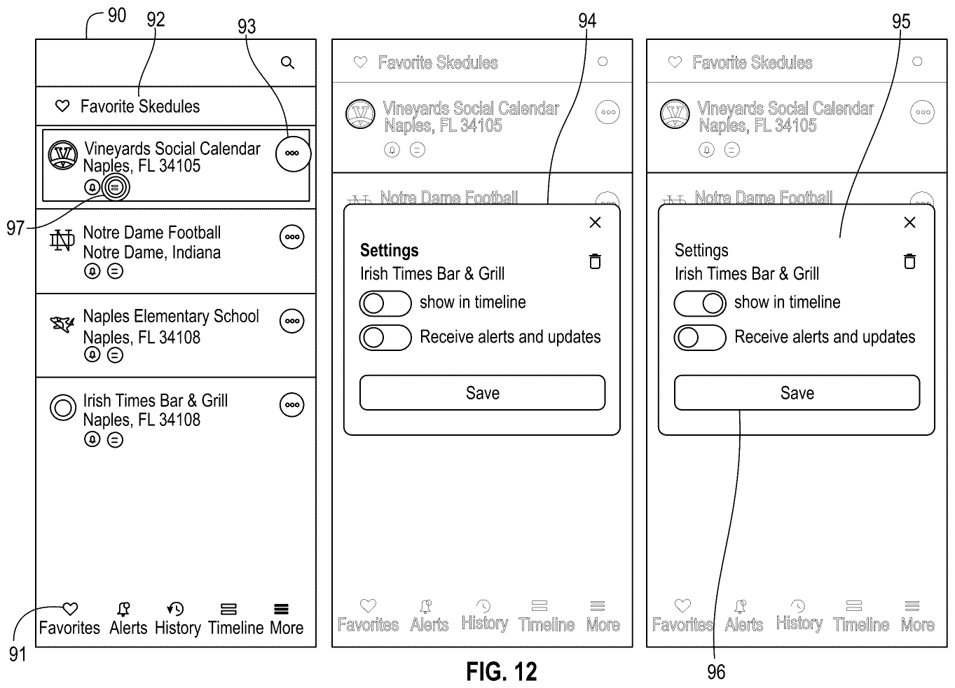

FIG. 12 shows an embodiment of a user interface display 90 for the process of adding a saved schedule to a timeline. In this embodiment, the user interface 90 displays a heart icon 91 in a navigation bar that, when pressed, causes the platform to display a saved schedules list 92. The options icon 93 for a specific schedule may be pressed causing the user interface 90 to display an overlay window 94. The overlay window 94 contains settings for the schedule 95, with one of those settings 95 providing the option of showing the specific schedule in a timeline. Once any changes are made to the specific schedule setting 95 displayed in the overlay window 94, the user may click the “save” button 96 to retain change, which may cause the platform to stop displaying the overlay window 94. If the setting option to show the specific schedule in the timeline is selected, a user may view the specific schedule in the timeline by clicking the timeline button 97 for that specific schedule.

Once a schedule is saved in the Saved Schedule List, Consumer C1 may select any number of schedules to integrate into their Timeline. A Timeline is a time saving feature allowing consumers to view multiple schedules at once. For example, if a person were following ten different musicians, they might want to integrate the multiple schedules into a single Timeline rather than open each schedule individually.

In this example Consumer C1 may view their Timeline in a listing or in a monthly view. The view of integrated schedules can be varied.

There many UI implementations which may be applied to accomplish the same task and process as outlined. These UI implementation differences should not impact the functionality sought for patent protection.

A Platform integrating multiple digital marketing calendars into, for example, a single Timeline is unique when consumers can click on, for example, an event thumbnail 101a and be referenced back to the complete schedule. A thumbnail image, in this example, is one iteration of connecting integrated events from different schedules back to the source schedule. Other methods such as icons or links may also be used to connect an event back to a full schedule in the platform. This functionality improves the visibility of the digital marketing schedule for the publisher and allows the Consumer to see other events from this schedule.

Personal calendars integrate event data but do not allow the user access from an event back to the original schedule from which the event came. From a marketing perspective publishers miss an important branding opportunity. Having access back to the complete original schedule from an integrated event list is very important for publishers who want consumers to see their schedule branding and easily access other available events.

### Step #9: Consumer C1 Views Timeline and Taps to Accesses Schedule P1-1A

The figures above are an example of Consumer C1 Timeline. In this example, the events of four separate schedules are integrated into a single Timeline. In this example, the events are listed in chronological order. The red circle highlights an icon in the navigation bar which is tapped to access Consumer C1Timeline. The green circle identifies the event thumbnail for Schedule P1-1A. The thumbnail links back to the complete schedule. In this example, the event is from Schedule P1-1A.

Consumer C1 taps on the Schedule P1-1A event thumbnail to view complete schedule. Event thumbnails can be associated with any integrated listing of events. Event thumbnails can also be used in an integrating listing of events such as a result of search.

Step #9a: Consumer taps an icon in the navigation bar to access their Timeline.

Step #9b: Platform receives the request, retrieves the Timeline from Consumer C1 Account and presents it to Consumer C1.

Step #9c: Consumer C1 views the Timeline and scrolls thru results.

Step #9d: Consumer C1 taps Schedule P1-1A event thumbnail image to view complete schedule.

Step #9e: Platform receives the request, retrieves Schedule P1-1A and presents to Consumer C1.

Step #9f: Consumer C1 views all events on Schedule P1-1A branded schedule.

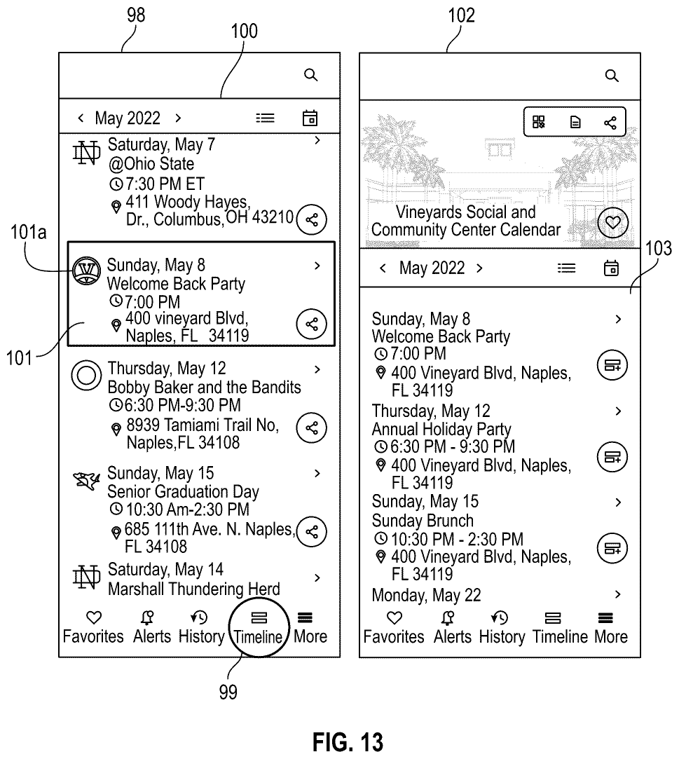

FIG. 13 shows an embodiment of a user interface 98 displayed after the timeline icon 99 in a navigation bar is selected. The timeline displayed on the user interface 98 shows a listing of events from different saved schedules in chronological order. To view events from a saved schedule for a specific publisher, a user may click on the event 101 listed. In response, the platform is operable to display a different user interface 102 showing a listing of events 103 for the specific schedule in chronological order.

Timelines are an integrated view of events from multiple schedules, each with an associated thumbnail 101a which helps identify the schedule from which it came. In personal calendars, the data can be integrated but it has no “connection” back to its original schedule from which the event came. An aggregated schedule is a timeline which can be published as a schedule. To do this, a user may be directed to the Publisher set up process as described in FIG. 2. User can select to create a Publisher or Consumer account from the same starting point.

### Step #10: Publisher Accesses and Reviews Dashboard for User Engagement for Schedule P1-1A

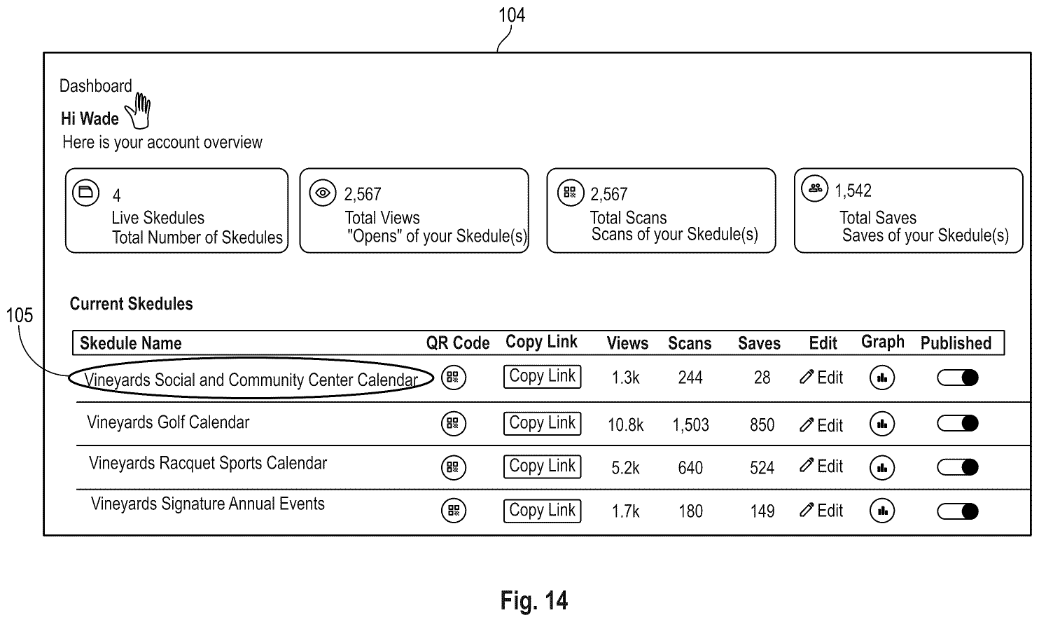

FIG. 14 shows an embodiment of a user interface display 104 for the dashboard access process carried out by the platform. In this embodiment, the process of accessing the dashboard includes the steps of a publisher navigating to and clicking on a dashboard icon. Once the icon is clicked, the platform is operable to respond by displaying a dashboard on the user interface 104. The dashboard shows metrics for user engagement for one or more specific schedules 105.

### Consumer Application or Website

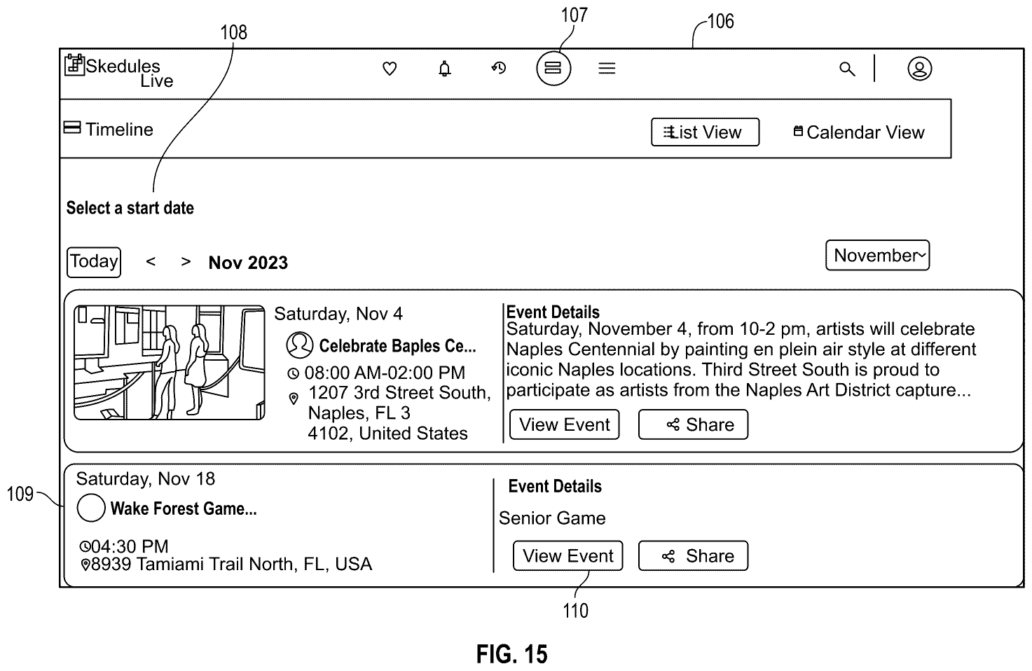

FIG. 15 shows a user interface display 106 for one embodiment of a scheduling application or website for consumers. In this embodiment, clicking on a timeline icon 107 in a navigation bar at the top of the user interface 106 causes the website to display a chronological listing of events 108 from one or more publishers. As previously described, clicking on a specific event thumbnail 109 may cause the platform to display a chronological listing of events for the schedule associated with the specific event 109. Alternatively, instead of viewing the schedule within the application or website for the platform, a consumer may wish to view a specific event detail on the publisher's website. Accordingly, the user interface 106 displays a “View Event” button 110, which may be a hyperlink to a publisher's external marketing website. Clicking the hyperlinked button 110 may direct a consumer to the publisher's external marketing website.

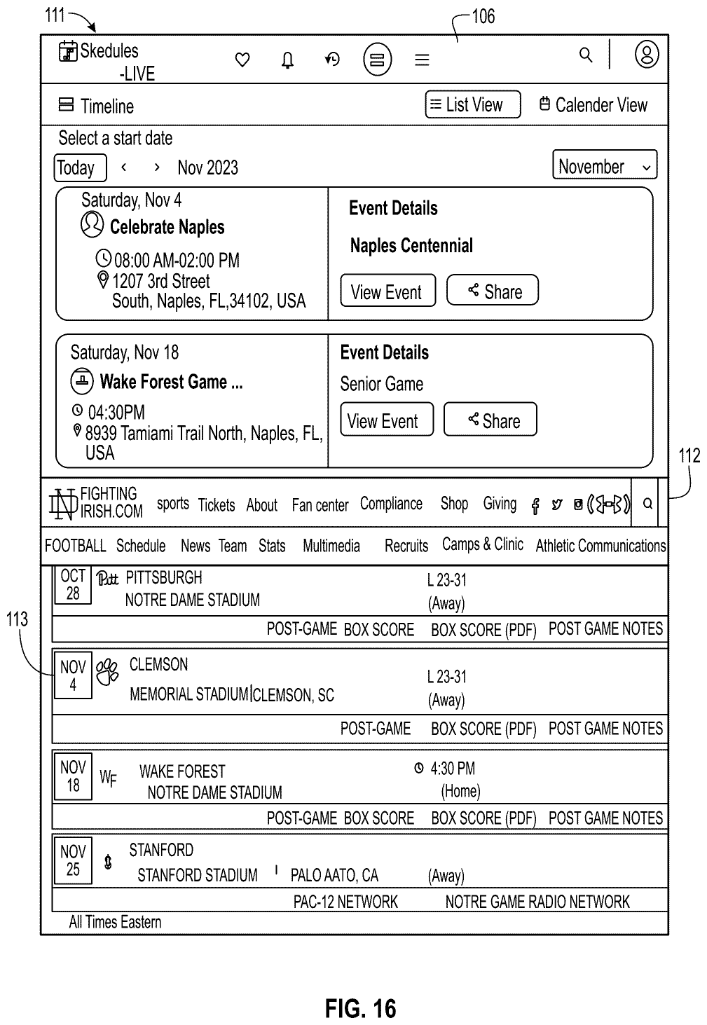

In one embodiment, instead of directing the consumer to an external marketing website for the specific publisher, the platform is operable to display a hybrid user interface. FIG. 16 shows one embodiment of the hybrid user interface 111 simultaneously displaying both the scheduling application 106 and the external marketing website 112 for the publisher. Specifically, when the platform receives an input selecting a hyperlink to an external website, the platform may be operable to display both the user interface for the scheduling website or application and the user interface for the external website. This allows the consumer to view the specific event details 113 on the external website.

While all of the embodiments described herein represent a technical improvement, the embodiment shown in FIG. 16 in particular illustrates a technical problem solved in the field of computers. It is common in the field of computers to only display one user interface per application or website at a time because there is generally a limited availability of display space on computer monitors or mobile device screens. This technical problem, which is specific to computers, can disrupt user workflow and potentially lead to a user losing track of their purpose for being on a particular website.

The present disclosure solves this problem by creating a hybrid user interface 111 that simultaneously displays both the scheduling application 106 and an external website 112. This helps users identify specific events to attend directly from an external website for a specific schedule without needing to navigate away from the user interface 106 for the scheduling application and potentially losing track of progress. In other words, this feature ensures that critical information is readily accessible and promotes efficient time management.

### Summary

This disclosure relates to schedules of events and more specifically, a unified process and methods to create, share, curate, integrate and view schedules of events and the associated QR Codes and Links to market and promote the schedule in a single platform bringing together publishers and consumers of schedules content.

This disclosure takes Publisher P1 on the journey from creating Schedule P1-1A, downloading the associated auto-generated QR Code, marketing and promoting the schedule, engaging with the Consumer C1 when they scan the QR Code associated with Schedule P1-1A.

Consumer C1, after scanning the QR Code for Schedule P1-1A and viewing the schedule, chooses to save Schedule P1-1A to their Saved Schedule List. Saving a schedule to a Saved Schedules List makes it easy to find and view at a later date.

Consumer C1 opens their Saved Schedules List and taps on Schedule P1-1A to open it in a single action. Consumer C1 decides to integrate Schedule P1-1A into their Timeline with other schedules from their Saved Schedule List.

This is unique as no other calendar or schedules application enables Publisher P1 to automatically generate a QR Code in the application in which the schedule was created (in this case Schedule P1-1A), download and use the QR Code to promote the schedule where the QR Code can be scanned by Consumer C1 and then enable Consumer C1 to save and integrate Schedule P1-1A into a Timeline.

This is superior to generic QR Codes which do not allow for saving, integrating and access to the complete schedule. By saving the schedule to the cloud, Consumer is always accessing the latest version of the schedule. Any changes and updates made by Publisher P1 to Schedule P1-1A are now immediately available Consumer C1. Changes and updates are available regardless of how the consumer views the schedule. This includes scanning the QR Code, accessing from their Saved Schedules List and/or clicking on an event thumbnail in a Timeline. Consumers are always looking at the latest published schedule and like knowing they are never looking at an outdated schedule. Another benefit is having a place where they can save and view all their schedules in a single place and needing only a single action to view any schedule in its discrete form.

In this process, Schedule P1-1A is created, marketed, viewed as a discrete schedule. After Consumer C1 saves Schedule P1-1A to their Saved Schedules List, they integrate it into their Timeline however; the event and thumbnail image link back to the discrete schedule.

Selected schedule and events can be added to an integrated timeline. This customized view of important schedules saves time and it eliminates the need to open schedules individually.

Using a thumbnail to link back to the source schedule when a listing of integrated are shown helps consumers explore the complete schedule.

Publishing an aggregates schedule from a timeline listing simplifies populating schedule content. In this model, the source schedules provide the input where events are integrated into a chronological listing.

While several variations of the present invention have been illustrated by way of example in preferred or particular embodiments, it is apparent that further embodiments could be developed within the spirit and scope of the present invention, or the inventive concept thereof. However, it is to be expressly understood that such modifications and adaptations are within the spirit and scope of the present invention, and are inclusive, but not limited to the following appended claims as set forth.

What is claimed is:

1. A scheduling system comprising:
a computer housing a processor and a memory, the memory storing instructions for execution by the processor;
a graphical user interface connected to the computer;
a user input device connected to the computer;
a service infrastructure connected to the computer;
wherein the computer and the service infrastructure are connected over a public network; and
wherein the scheduling system is operable to create a schedule and automatically generate a unique matrix code and a unique link for the schedule.

2. The scheduling system of claim 1 further comprising a camera connected to the computer.

3. The scheduling system of claim 2 wherein the camera is configured to scan the unique matrix code, and the processor is operable to display a savable schedule on the graphical user interface.

4. The scheduling system of claim 3 wherein the processor is operable to add the savable schedule to a listing of favorite schedules in a first single action.

5. The scheduling system of claim 4 wherein the processor is operable to display the listing of favorite schedules on the graphical user interface and open a first schedule from the listing of favorite schedules with a second single action.

6. The scheduling system of claim 5 wherein the processor is operable to open a second schedule from the listing of favorite schedules without being operable to close the first schedule.

7. The scheduling system of claim 1 wherein the user input device comprises at least one of a keyboard or a touch screen.

8. The scheduling system of claim 7 wherein the processor is operable to:
receive a click from at least one of the keyboard or the touch screen selecting the unique link;
display a savable schedule on the graphical user interface; and
add the savable schedule to a listing of favorite schedules in a single action.

9. The scheduling system of claim 1 wherein the scheduling system is operable to constantly update the schedule so that the schedule displayed on the graphical user interface is always current.

10. The scheduling system of claim 1 wherein the processor is operable to simultaneously display a hyperlink to a social media website, the unique matrix code, and the unique link on the graphical user interface for marketing the schedule.

11. The scheduling system of claim 1 wherein the processor is operable to automatically update a dashboard when either the unique matrix code is scanned, or the unique link is clicked, and display the dashboard on the graphical user interface.

12. The scheduling system of claim 1 wherein the processor is operable to integrate a plurality of schedules and a plurality of events into a single integrated listing.

13. The scheduling system of claim 12 wherein the single integrated listing is a timeline, and the processor is operable to display the timeline on the graphical user interface without displaying a personal calendar.

14. The scheduling system of claim 13 wherein the timeline displayed on the graphical user interface auto-populates and can be named and marketed as the schedule.

15. The scheduling system of claim 13 wherein the processor is operable to display the plurality of schedules and the plurality of events as the timeline, and at least one of the plurality of schedules comprises a thumbnail, which links back to a complete schedule stored within the service infrastructure for the scheduling system.

16. A method for creating and promoting schedules carried out by a first computer housing a first processor and a first memory, the first memory storing instructions for execution by the first processor, wherein, upon execution, the first processor is operable to perform the following steps:
displaying at least one of a scheduling application or a scheduling website on a user interface;
receiving a plurality of credentials for an account creation;
verifying a user identity and creating the account;
displaying a template for creating a schedule on the user interface;
receiving a plurality of inputs on the template to create the schedule; and
creating the schedule.

17. The method of claim 16 further comprising saving the schedule on a database.

18. The method of claim 16 further comprising generating at least one of a matrix code or a link for the schedule.

19. The method of claim 18 further comprising:
downloading at least one of the matrix code or the link;
a second computer housing a second processor and a second memory, the second memory storing instructions for execution by the second processor;
wherein, upon execution, the second processor is operable to perform at least one of scanning the matrix code or clicking on the link.

20. The method of claim 19 further comprising displaying, by the second processor, the schedule on a second user interface in response to a single action command received by the second processor.
